(19) United States
(12) Patent Application Publication
(10) Pub. No.: US 2025/0000304 A1
(43) Pub. Date: Jan. 2, 2025

(54) FOLDABLE SEASONING RACK

(71) Applicant: Lan Yu, Luotian (CN)

(72) Inventor: Lan Yu, Luotian (CN)

(21) Appl. No.: 18/829,671

(22) Filed: Sep. 10, 2024

(51) Int. Cl. A47J 47/16; A47B 43/00

(52) U.S. Cl. CPC A47J 47/16; A47B 43/00

(57) ABSTRACT

The present disclosure relates to the technical field of seasoning racks and discloses a foldable seasoning rack, including a rear plate, a first side guardrail, a second side guardrail, an upper supporting plate, a middle supporting plate, a lower supporting plate, and a plurality of dense nets. Upper hooks are fixedly arranged at front positions of upper sides of opposite side end surfaces of the first side guardrail and the second side guardrail. Middle hooks are fixedly arranged at front positions, close to the middle, of the opposite side end surfaces of the first side guardrail and the second side guardrail. In the present disclosure, seasoning bottles can be better protected; the possibility of falling of short bottles is reduced; the placement of seasoning bottles with different heights is facilitated. Furthermore, the seasoning rack can be folded. The foldable seasoning rack is more convenient for transportation and carrying.

### TECHNICAL FIELD

The present disclosure relates to the technical field of seasoning racks, and in particular, to a foldable seasoning rack.

### BACKGROUND

A seasoning rack is a kitchen utensil configured to store various seasonings, such as salt, sugar, soy sauce, vinegar, and spices. The seasoning rack can help keep a kitchen clean, clarify the classification of seasonings, and facilitate daily cooking. Seasoning racks include a wall-mounted seasoning rack, a vertical seasoning rack, a rotating seasoning rack, and a drawer type seasoning rack. Different seasoning racks can accommodate seasoning bottles in different quantities.

Most existing seasoning racks do not have guardrails, so that seasonings easily fall off. The fixed design of the seasoning racks, it is impossible to place seasoning bottles with different heights. Furthermore, due to the fixed arrangement, the volume cannot be changed, so that it is inconvenient for transportation. Therefore, a person skilled in the art provides a foldable seasoning rack to solve the problems mentioned in the background section.

### SUMMARY

The present disclosure aims to solve the defects in the prior art, and provides a foldable seasoning rack, to reduce the possibility of falling of seasoning bottles. The seasoning rack can be folded and is convenient for transportation.

To achieve the above objective, the present disclosure provides the following technical solution: A foldable seasoning rack includes a rear plate, a first side guardrail, a second side guardrail, an upper supporting plate, a middle supporting plate, a lower supporting plate, and a plurality of dense nets. The first side guardrail, the second side guardrail, and the rear plate are all connected by two first movable hinges; two sides of the upper supporting plate, two sides of the middle supporting plate, and two sides of the lower supporting plate are respectively connected to the rear plate by two second movable hinges in a hinged manner;
upper hooks are fixedly arranged at front side positions of upper sides of opposite side end surfaces of the first side guardrail and the second side guardrail; middle hooks are fixedly arranged at front side positions, close to the middle, of the opposite side end surfaces of the first side guardrail and the second side guardrail; and lower hooks are fixedly arranged at front side positions of lower sides of the opposite side end surfaces of the first side guardrail and the second side guardrail.

Further, plastic pads are fixedly arranged at lower ends of the first side guardrail and the second side guardrail; and the first side guardrail and the second side guardrail are respectively arranged on two sides of the rear plate.

Further, the plurality of dense nets are fixedly arranged on inner walls of the two sides of the upper supporting plate, inner walls of the two sides of the middle supporting plate, and inner walls of the two sides of the lower supporting plate.

Further, the upper supporting plate is arranged on an upper side of a front end surface of the rear plate, and the upper supporting plate is clamped on upper end surfaces of the two upper hooks.

Further, the middle supporting plate is arranged at a lower middle position of a front end surface of the rear plate, and the middle supporting plate is clamped on upper end surfaces of the two middle hooks.

Further, the lower supporting plate is arranged on a lower side of a front end surface of the rear plate, and the lower supporting plate is clamped on upper end surfaces of the two lower hooks.

The present disclosure has the following beneficial effects:

1. According to the foldable seasoning rack in the present disclosure, since the seasoning rack has the design of guardrails, seasoning bottles can be better protected, and the possibility of falling of short seasoning bottles is reduced. Furthermore, the upper supporting plate is movably connected to the rear plate through the second movable hinges and can be directly pulled apart, so that the placement of seasoning bottles with different heights is facilitated. Meanwhile, due to the three-layer design, the number of seasoning bottles that can be placed is increased.

2. According to the foldable seasoning rack in the present disclosure, the rear plate of the seasoning rack is connected to the first side guardrail, the second side guardrail, the upper supporting plate, the middle supporting plate, and the lower supporting plate through the movable hinges, so that it is more convenient to assemble the seasoning rack. Furthermore, the seasoning rack can be folded. The foldable seasoning rack is more convenient for transportation and carrying.

### BRIEF DESCRIPTION OF THE DRAWINGS

FIG. 1 is a schematic axonometric diagram of the present disclosure;

FIG. 2 is a schematic diagram of a bottom view of the present disclosure;

FIG. 3 is a schematic diagram of a rear view of the present disclosure; and

FIG. 4 is a schematic axonometric diagram of the present disclosure without dense nets.

### REFERENCE NUMERALS

1: upper supporting plate; 2: first side guardrail; 3: middle hook; 4: middle supporting plate; 5: plastic pad; 6: lower supporting plate; 7: dense net; 8: second side guardrail; 9: first movable hinge; 10: rear plate; 11: second movable hinge; 12; upper hook; and 13: lower hook.

### DETAILED DESCRIPTION OF THE EMBODIMENTS

The technical solutions in the embodiments of the present disclosure are clearly and completely described below with reference to the accompanying drawings in the embodiments of the present disclosure. Apparently, the described embodiments are merely some embodiments of the present disclosure, rather than all the embodiments. All other embodiments obtained by a person of ordinary skill in the art based on the embodiments of the present disclosure without making creative efforts shall fall within the protection scope of the present disclosure.

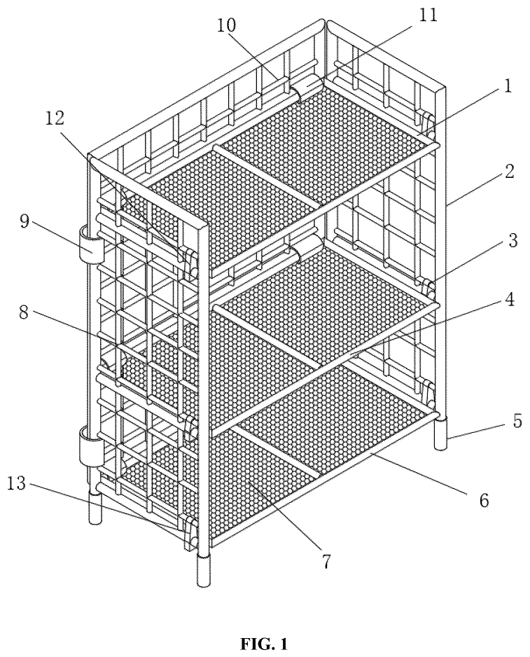

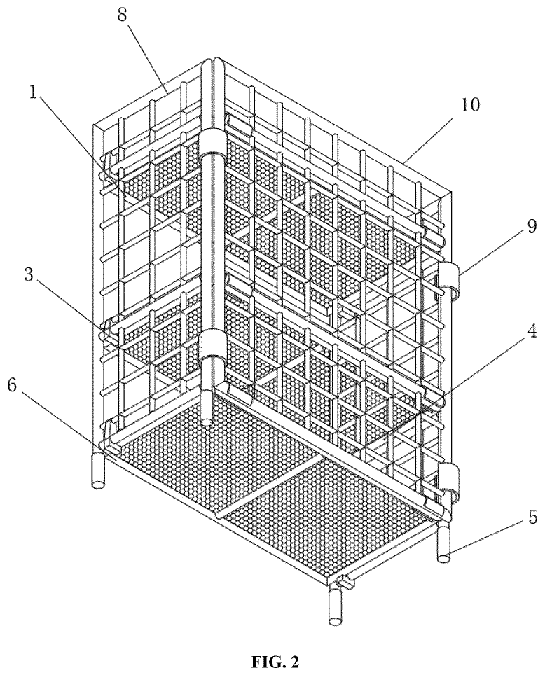

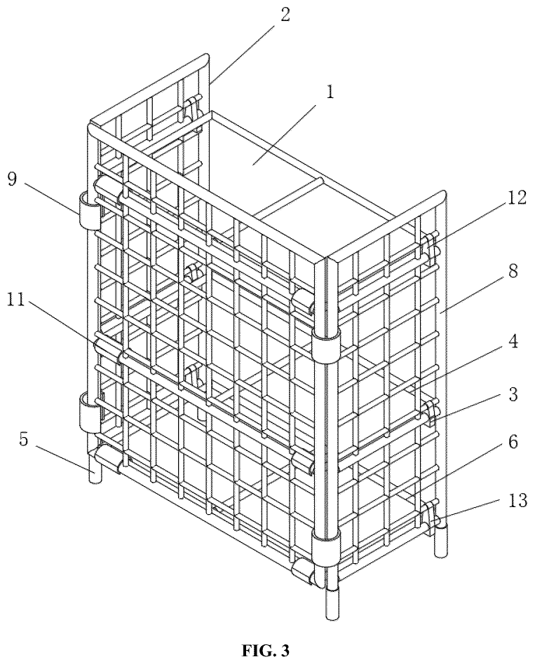

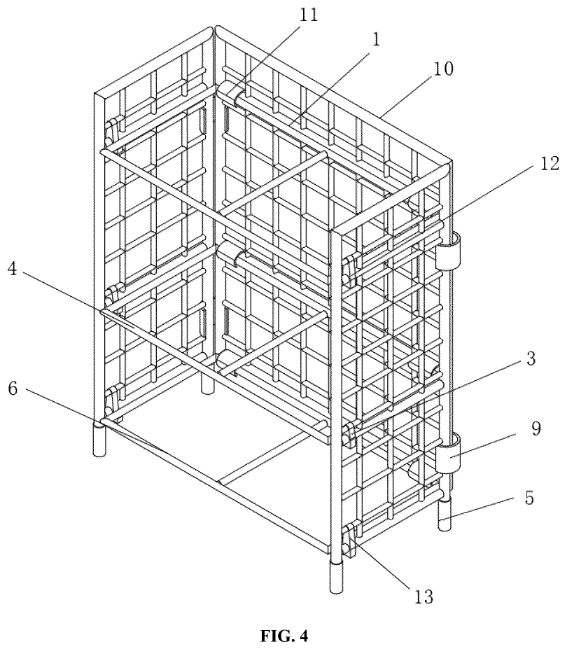

Referring to FIG. 1, FIG. 2, FIG. 3, and FIG. 4, the present disclosure provides an embodiment: A foldable seasoning rack includes a rear plate 10, a first side guardrail 2, a second side guardrail 8, an upper supporting plate 1, a middle supporting plate 4, a lower supporting plate 6, and a plurality of dense nets 7. The first side guardrail 2, the second side guardrail 8, and the rear plate 10 are all connected by two first movable hinges 9. Two sides of the upper supporting plate 1, two sides of the middle supporting plate 4, and two sides of the lower supporting plate 6 are respectively connected to the rear plate 10 by two second movable hinges 11 in a hinged manner.

Upper hooks 12 are fixedly arranged at front positions of upper sides of opposite side end surfaces of the first side guardrail 2 and the second side guardrail 8; middle hooks 3 are fixedly arranged at front positions, close to the middle, of the opposite side end surfaces of the first side guardrail 2 and the second side guardrail 8; and lower hooks 13 are fixedly arranged at front positions of lower sides of the opposite side end surfaces of the first side guardrail 2 and the second side guardrail 8.

Plastic pads 5 are fixedly arranged at lower ends of the first side guardrail 2 and the second side guardrail 8. The first side guardrail 2 and the second side guardrail 8 are respectively arranged on two sides of the rear plate 10. The plurality of dense nets 7 are respectively fixedly arranged on inner walls of the two sides of the upper supporting plate 1, inner walls of the two sides of the middle supporting plate 4, and inner walls of the two sides of the lower supporting plate 6. The upper supporting plate 1 is arranged on an upper side of a front end surface of the rear plate 10, and the upper supporting plate 1 is clamped on upper end surfaces of the two upper hooks 12. The middle supporting plate 4 is arranged at a lower middle position of the front end surface of the rear plate 10, and the middle supporting plate 4 is clamped on upper end surfaces of the two middle hooks 3. The lower supporting plate 6 is arranged on a lower side of the front end surface of the rear plate 10, and the lower supporting plate 6 is clamped on upper end surfaces of the two lower hooks 13.

Specifically, first, the first side guardrail 2 and the second side guardrail 8 are respectively mounted on the two sides of the rear plate 10 through the first movable hinges 9. Then, the upper supporting plate 1, the middle supporting plate 4, and the lower supporting plate 6 are mounted on the upper, middle, and lower front sides of the rear plate 10 through the second movable hinges 11. The upper supporting plate 1 is flipped upwards. The lower supporting plate 6 is then flipped to enable the lower supporting plate 6 to press the lower hooks 13. Next, the middle supporting plate 4 is flipped to enable the middle supporting plate 4 to press the middle hooks 3. Then, the upper supporting plate 1 is flipped to enable the upper supporting plate 1 to press the upper hooks 12. Moreover, the upper supporting plate 1 is inclined and can be configured to place objects of different shapes and sizes and items that fall off difficultly.

Working principle: The first side guardrail 2 and the second side guardrail 8 are flipped to the front side. First, the lower supporting plate 6 is placed on the lower front side of the rear plate 10. The two sides of the lower supporting plate 6 are put in the lower hooks 13 for being pressed. Next, the upper supporting plate 1 is placed on the upper front side of the rear plate 10. The middle supporting plate 4 is put into the front part of the rear plate 10, and the two sides of the supporting plate are pressed into the middle hooks 3. Finally, the upper supporting plate 1 is put into the upper hooks 12. After that, items can be stored placed normally. The dense nets 7 are arranged on the first supporting plate, the second supporting plate, and the third supporting plate. The small dense nets 7 are designed to hold small items, and the seasoning rack stands on a tabletop through the plastic pads 5.

It should be finally noted that the above describes only the preferred embodiments of the present disclosure and is not intended to limit the present disclosure. Although the present disclosure is described in detail with reference to the foregoing embodiments, a person skilled in the art may still make modifications to the technical solutions described in the foregoing respective embodiments or make equivalent replacements to partial technical features thereof. Any modification, equivalent replacement, improvement, and the like made within the spirit and principle of the present disclosure shall fall within the protection scope of the present disclosure.

What is claimed is:

1. A foldable seasoning rack, comprising a rear plate (10), a first side guardrail (2), a second side guardrail (8), an upper supporting plate (1), a middle supporting plate (4), a lower supporting plate (6), and a plurality of dense nets (7), wherein the first side guardrail (2), the second side guardrail (8), and the rear plate (10) are all connected by two first movable hinges (9); two sides of the upper supporting plate (1), two sides of the middle supporting plate (4), and two sides of the lower supporting plate (6) are respectively connected to the rear plate (10) by two second movable hinges (11) in a hinged manner;
upper hooks (12) are fixedly arranged at front positions of upper sides of opposite side end surfaces of the first side guardrail (2) and the second side guardrail (8); middle hooks (3) are fixedly arranged at front positions, close to the middle, of the opposite side end surfaces of the first side guardrail (2) and the second side guardrail (8); and lower hooks (13) are fixedly arranged at front positions of lower sides of the opposite side end surfaces of the first side guardrail (2) and the second side guardrail (8).

2. The foldable seasoning rack according to claim 1, wherein plastic pads (5) are fixedly arranged at lower ends of the first side guardrail (2) and the second side guardrail (8); and the first side guardrail (2) and the second side guardrail (8) are respectively arranged on two sides of the rear plate (10).

3. The foldable seasoning rack according to claim 1, wherein the plurality of dense nets (7) are fixedly arranged on inner walls of the two sides of the upper supporting plate (1), inner walls of the two sides of the middle supporting plate (4), and inner walls of the two sides of the lower supporting plate (6).

4. The foldable seasoning rack according to claim 1, wherein the upper supporting plate (1) is arranged on an upper side of a front end surface of the rear plate (10), and the upper supporting plate (1) is clamped on upper end surfaces of the two upper hooks (12).

5. The foldable seasoning rack according to claim 1, wherein the middle supporting plate (4) is arranged at a lower middle position of a front end surface of the rear plate (10), and the middle supporting plate (4) is clamped on upper end surfaces of the two middle hooks (3).

6. The foldable seasoning rack according to claim 1, wherein the lower supporting plate (6) is arranged on a lower side of a front end surface of the rear plate (10), and the lower supporting plate (6) is clamped on upper end surfaces of the two lower hooks (13).
